(19) United States
(12) Patent Application Publication
(10) Pub. No.: US 2009/0111903 A1
(43) Pub. Date: Apr. 30, 2009

(54) METHOD OF MAKING POLYURETHANE FOAM

(75) Inventors: Thomas Savino, Northville, MI (US); Joseph Ogonowski, Newport, MI (US); Brian Hyduk, Canton, MI (US); Sandra Bananto, Dearborn, MI (US)

Correspondence Address: BASF AKTIENGESELLSCHAFT, CARL-BOSCH STRASSE 38, 67056 LUDWIGSHAFEN, LUDWIGSHAFEN, 69056, DE

(73) Assignee: BASF Corporation

(21) Appl. No.: 11/930,852

(22) Filed: Oct. 31, 2007

(51) Int. Cl. C08G 18/08

(52) U.S. Cl. 521/160

(57) ABSTRACT

An isocyanate prepolymer is made by providing an isocyanate component. A phosphite that is free of active hydrogen groups is introduced into the isocyanate component. An isocyanate-reactive component and a stoichiometric excess of the isocyanate component are reacted in the presence of the phosphite to make the isocyanate prepolymer. A polyurethane foam is made by reacting the isocyanate prepolymer and a second isocyanate-reactive component in the presence of a blowing agent. A composite article is made by forming an elastomeric layer on the outer surface of the polyurethane foam core. Due to the presence of the phosphite during reaction of the isocyanate component and the isocyanate-reactive component to make the isocyanate prepolymer, more efficient use of the phosphite is made, and the full color-reducing effect of the phosphite on the polyurethane foam is realized.

### FIELD OF THE INVENTION

The present invention generally relates to a method of making polyurethane foam and a method of making an isocyanate prepolymer. More specifically, the present invention relates to a method of making an isocyanate prepolymer having low color.

### BACKGROUND OF THE INVENTION

Polyurethane foams and isocyanate prepolymers are well known in the art. The polyurethane foams are formed from the reaction of an isocyanate component, which may include the isocyanate prepolymer, and an isocyanate-reactive component. One particularly useful application for polyurethane foams is in surfboards. Specifically, a polyurethane foam core is coated with a fabric-reinforced elastomeric layer to make the surfboards. One problem that typically arises with polyurethane foams that are used as the core in surfboards is discoloration in the polyurethane foam due to the presence of organic moieties that are present in the isocyanate component prior to formation of the foam. Although the polyurethane foam cores are not typically visible in the surfboards, nicks or other damage to the fabric-reinforced elastomeric layer may expose the polyurethane foam core, and discolored polyurethane foam is aesthetically undesirable.

It is well known in the art that stabilizers can be added to either the isocyanate component or the isocyanate-reactive component prior to formation of the polyurethane foam in order to reduce discoloration of the foam. Phosphites are one class of stabilizers that is known to reduce discoloration in polyurethane foams.

When added to the isocyanate component or the isocyanate-reactive component, relatively large amounts of the stabilizer are typically required to have an appreciable effect on reduction of discoloration of the polyurethane foams. The relatively large amounts of the stabilizer result in higher production costs and may result in undesirable properties of the polyurethane foam. Further, a full color-reducing effect provided by the stabilizer may not be realized by adding the stabilizer to the isocyanate component or the isocyanate-reactive component, which may leave room for further reduction in discoloration of the polyurethane foam. In addition, stabilizers may prove ineffective if the isocyanate component itself contains color. Polyurethane foams prepared from yellow isocyanate prepolymers may appear yellow even in the presence of stabilizers such as phosphites because such stabilizers may be ineffective in removing the color already present in the isocyanate prepolymer.

As a result of the deficiencies of the prior art, there remains an opportunity to provide a method of making polyurethane foam and a method of making an isocyanate prepolymer that may make more efficient use of the stabilizer to realize the full color-reducing effect of the stabilizer on the polyurethane foam.

### SUMMARY OF THE INVENTION AND ADVANTAGES

The subject invention provides a method of making a polyurethane foam, a method of making an isocyanate prepolymer, and a method of making a composite article. To make the isocyanate prepolymer, an isocyanate component is provided. A phosphite that is free of active hydrogen groups is introduced into the isocyanate component. An isocyanate-reactive component and a stoichiometric excess of the isocyanate component are reacted in the presence of the phosphite to make the isocyanate prepolymer.

To make the polyurethane foam, the isocyanate prepolymer is provided. The isocyanate prepolymer and a second isocyanate-reactive component are reacted in the presence of a blowing agent to make the polyurethane foam.

To make the composite article, a polyurethane foam core is provided. An elastomeric layer is formed on the outer surface of the polyurethane foam core.

Due to the presence of the phosphite during reaction of the isocyanate component and the isocyanate-reactive component to make the isocyanate prepolymer, more efficient use of the phosphite is made, and the full color-reducing effect of the phosphite on the polyurethane foam is realized. This may result in lower required amounts of the phosphite than may be otherwise required, and therefore may result in cost savings.

### DETAILED DESCRIPTION OF A PREFERRED EMBODIMENT

A composite article made in accordance with the present invention includes a polyurethane foam core. The polyurethane foam core includes a polyurethane foam that is made in accordance with the present invention. The composite article may be any article that includes the polyurethane foam core having an outer surface with an elastomeric layer formed on the outer surface. One specific example of a composite article made in accordance with the present invention is a surfboard, and the polyurethane foam core may be further defined as a surfboard core. However, the composite article may also be suitable for a variety of other applications, especially applications in which the composite articles are exposed to water.

Typically, the elastomeric layer covers at least about 50% of the outer surface of the polyurethane foam core, in which case the composite article may be a layered structure with the elastomeric layer on one side of composite article. More typically, the elastomeric layer covers at least 90% of the polyurethane foam core, thereby essentially encapsulating the polyurethane foam core. The surfboard is an example of the composite article that is essentially encapsulated by the elastomeric layer.

The polyurethane foam is typically a rigid polyurethane foam, and the polyurethane foam core typically provides structure and support for the composite article. However, it is to be appreciated that the polyurethane foam made in accordance with the present invention is not limited to rigid polyurethane foams, and may alternatively be a flexible polyurethane foam. Particularly suitable composite article applications for the polyurethane foams of the present invention include those where the polyurethane foam is intended to be hidden from view, but where the polyurethane foam may become visually exposed due to normal wear and tear experienced by the composite article.

The polyurethane foam is formed from an isocyanate prepolymer that includes the reaction product of an isocyanate-reactive component and a stoichiometric excess of an isocyanate component in the presence of a phosphite free of active hydrogen groups. Stated differently, some, but not all, isocyanate groups of the isocyanate component are reacted with the isocyanate-reactive component to make the isocyanate prepolymer, which provides advantages over non-prepolymer isocyanate components as set forth below. Because the isocyanate prepolymer is available for further reaction to form the polyurethane foam, the isocyanate prepolymer, although technically including urethane groups resulting from the reaction of the isocyanate groups of the isocyanate component and the isocyanate reactive component, is not considered to be a “urethane” as the term is generally used in the art, i.e., the isocyanate prepolymer is not a final polymerized product that is free of isocyanate-reactive groups. Rather, the isocyanate prepolymer is characterized as an isocyanate that is used to form the polyurethane foam, with the polyurethane foam being the final polymerization product of the isocyanate prepolymer and a second isocyanate-reactive component in the presence of a blowing agent.

The isocyanate component may be a diisocyanate having about two isocyanate groups per molecule, or may be a polyisocyanate having more than two isocyanate groups per molecule. The isocyanate component generally corresponds to the formula R(NCO)_{z} wherein R is an organic chain and z is an integer which corresponds to the functionality of R and is at least two. R may include an aromatic group, however, R may also be an aliphatic group. Representative of the types of organic isocyanates contemplated herein include, for example, bis(3-isocyanatopropyl)ether, 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitrobenzene, 2,5-diisochyanato-1-nitrobenzene, m-phenylene diisocyanate, p-phenylene diisocyanate, 2,4-toluene diisocyanate, 2,6-toluene diisocyanate, mixtures of 2,4- and 2,6-toluene diisocyanate, 1,5-naphthalene diisocyanate, 1-methoxy-2,4-phenylene diisocyanate, 4,4′-diphenylmethane diisocyanate, 2,4′-diphenylmethane diisocyanate, 4,4′-biphenylene diisocyanate, 3,3′-dimethyl-4,4′-diphenylmethane diisocyanate, and 3,3′-dimethyldiphenylmethane-4,4′-diisocyanate; triisocyanates such as 4,4′,4″-triphenylmethane triisocyanate; polymeric isocyanates such as polymethylene polyphenylene polyisocyanate and 2,4,6-toluene triisocyanate; and tetraisocyanates such as 4,4′-dimethyl-2,2′-5,5′-diphenylmethane tetraisocyanate. Especially useful due to their availability and properties are monomeric diisocyanates including pure 2,4′-diphenylmethane diisocyanate, pure 4,4′-diphenylmethane diisocyanate, and combinations thereof. A specific example of a suitable isocyanate component is Lupranate® MI commercially available from BASF Corporation of Mount Olive, N.J.

The isocyanate component is typically the diphenylmethane diisocyanate due to known advantages over other types of isocyanates such as toluene diisocyanates. Among other advantages, diphenylmethane diisocyanates have a lower vapor pressure than toluene diisocyanates and therefore require less stringent environmental controls as compared to the toluene diisocyanates. However, diphenylmethane diisocyanates typically have a high freeze point of about 75° F., which makes the diphenylmethane diisocyanates difficult to transport and store due to a need to maintain the diphenylmethane diisocyanates in liquid form. Further, it is desirable to increase functionality of the isocyanate to provide rigidity and green strength to the resulting polyurethane foam. For this reason, among others, the isocyanate prepolymer is made, which has a lower freeze point and generally remains in a liquid state at normal transportation and storage temperatures. The isocyanate prepolymer also decreases demold and cure time of the resulting polyurethane foam, produces a whiter foam than the isocyanate alone, and increases the viscosity of the isocyanate.

The isocyanate-reactive component that is reacted with the isocyanate component to make the isocyanate prepolymer may be selected from the group of polyols, amines, and combinations thereof. Typically, the isocyanate-reactive component has a nominal functionality of at least 3. Use of the isocyanate-reactive component having the nominal functionality of at least 3 to make the isocyanate prepolymer results in decreased demolding and cycle time for polyurethane foams made from the isocyanate prepolymer, as compared to demold and cycle times for non-prepolymer diphenylmethane diisocyanates. Further, use of the isocyanate-reactive component having the nominal functionality of at least 3 to make the isocyanate prepolymer also results in finer cell structure as compared to cell structure that is obtained by using non-prepolymer diphenylmethane diisocyanates to make the polyurethane foam.

Specific examples of isocyanate-reactive components that have a nominal functionality of at least 3 are selected from the group of trimethylol propane-initiated polyether polyols, glycerin-initiated polyether polyols, pentaerythritol-initiated polyether polyols, and combinations thereof. An example of a particularly suitable isocyanate-reactive component, for purposes of the subject invention, is a pentaerythritol-initiated propylene oxide adduct commercially available from BASF Corporation. Other suitable isocyanate-reactive components may include a glycerin-initiated propylene oxide/ethylene oxide adduct, a trimethylolpropane-initiated propylene oxide/ethylene oxide adduct, and combinations thereof, all commercially available from BASF Corporation.

As alluded to above, the isocyanate prepolymer is used to make the polyurethane foam due to a low freeze point of the isocyanate prepolymer, among other advantages, as compared to non-prepolymer isocyanates of comparable NCO content. The low freeze point is more typically defined as a freeze point of less than or equal to 50° F., more typically less than 30° F., and most typically less than 23° F. The low freeze point of the isocyanate prepolymer within the above parameters provides processing advantages over non-prepolymer isocyanates having higher freeze points due to the fact that the isocyanate prepolymers generally remain in a liquid state at normal processing temperatures. Further, the isocyanate prepolymer makes whiter polyurethane foam than the isocyanate by itself, especially when the isocyanate-reactive component is the pentaerythritol-initiated propylene oxide adduct. It is believed that the whiter polyurethane foam is obtained due to a reduction in foam exotherm resulting from reacting a significant amount of the isocyanate functionalities in the isocyanate.

The isocyanate prepolymer formed from the diphenylmethane diisocyanate typically has an NCO content of from about 20% to about 35%, more typically from about 23% to about 31%, most typically from about 25% to about 30%. The NCO content in the above ranges minimizes a difference in feed ratios between the isocyanate prepolymer and the isocyanate-reactive component to maximize throughput in dispensing equipment. The combination of the low freeze point, as defined above, and the NCO content in the above ranges makes the isocyanate prepolymer advantageous over non-prepolymer isocyanates that have higher freeze points.

As set forth above, the isocyanate prepolymer is made in the presence of the phosphite. The subject invention has discovered that the presence of the phosphite during the reaction between the isocyanate component and the isocyanate-reactive component to make the isocyanate prepolymer results in the isocyanate prepolymer having reduced color. Without intending to be bound to any particular theory, it is believed that the phosphite neutralize moieties that are typically present in the isocyanate component and that result in discoloration of the resulting polyurethane foam due to oxidation of the moieties when exposed to heat. By neutralizing the moieties before or during making of the isocyanate prepolymer, the isocyanate prepolymer has less discoloration than would otherwise be possible with later addition of the phosphite. It is believed that neutralization of the moieties can also take place during making of the isocyanate prepolymer. The moieties can lead to the formation of color bodies which impart a yellow color to the prepolymer, and once the color bodies are formed in the prepolymer, the subsequent addition of phosphite is less effective at reducing color formation in the polyurethane foam.

The phosphite is typically represented by the general structure:

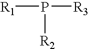

wherein R₁, R₂, and R₃ are independently selected from the group of an alkylene radical having at least 3 carbon atoms, an aryl radical, and combinations thereof, provided that at least two of R₁, R₂, and R₃ comprise the alkylene radical having at least 3 carbon atoms. More typically, R₁, R₂, and R₃ are independently selected from the group of an alkylene radical having from 3 to 10 carbon atoms, an aryl radical, and combinations thereof. Most typically, R₁, R₂, and R₃ are independently selected from the group of a butylene radical, a decylene radical, a phenyl radical, and combinations thereof. Specific examples of phosphites that are suitable for purposes of the present invention are selected from the group of, but are not limited to, tributyl phosphite, diisodecylphenyl phosphite, and combinations thereof. Examples of other phosphites that may also be suitable for purposes of the present invention include those selected from the group of, but are not limited to, trimethyl phosphite, triethyl phosphite, and combinations thereof.

The phosphite is typically present in the isocyanate prepolymer in an amount of from about 0.02 to about 0.055 parts by weight, more typically from about 0.02 to about 0.03 parts by weight, based on 100 parts by weight of the isocyanate component, the phosphite, and the isocyanate-reactive component on a pre-reaction basis. The phosphite is typically introduced into the isocyanate component in the above amounts prior to the reaction between the isocyanate component and the isocyanate-reactive component to make the isocyanate prepolymer. Due to the presence of the phosphite prior to making the isocyanate prepolymer, less phosphite is typically required to attain an appreciable effect on reduction of discoloration as compared to phosphite that is added after the isocyanate prepolymer is made.

Other additives may also be included in the isocyanate prepolymer. For example, the additive may be selected from the group of aromatic carboxylic acid chlorides, inorganic acids, aliphatic carboxylic acids, and combinations thereof. Examples of suitable aromatic carboxylic acid chlorides include, but are not limited to, benzoyl chloride or isophthalic acid chloride. Examples of inorganic acids include, but art not limited to, hydrochloric acid or phosphoric acid. Examples of aliphatic carboxylic acids include, but are not limited to, acetic acid, chloroacetic acid or propionic acid, or their acid anhydrides. The additives can be added to the isocyanate prepolymer as reaction controlling agents. Most typically the additive is benzoyl chloride. The additive may be present in the isocyanate prepolymer in an amount of at least 0.001 parts by weight, more typically from 0.001 to 0.01 parts by weight, based on 100 parts by weight of the isocyanate component, the phosphite, and the isocyanate-reactive component on a pre-reaction basis.

One method of determining the color of the isocyanate prepolymer utilizes the well known CIE L*A*B* (CIELAB) Color Space Specification. The CIELAB has three values, L*, A*, and B*. L* represents lightness and darkness of a color, A* represents redness-greenness, and B* represent yellowness-blueness. As known in the art, positive B* values indicate a more yellow color, with higher numbers indicating a more intense yellow color, and negative B* values indicate a more blue color, with lower numbers indicating more intense blue color. The presence of the phosphite during the reaction of the isocyanate component and the isocyanate-reactive component to make the isocyanate prepolymer results in a B* value of less than or equal to about 5.0, more typically a B* value of less than or equal to about 4.0. The B* values within the aforementioned ranges may be achieved when the phosphite is introduced into the isocyanate component as set forth above in the amounts set forth above, which may not be possible when the phosphites are introduced into the isocyanate prepolymer after the isocyanate prepolymer is already made.

To make the isocyanate prepolymer, the isocyanate component is provided. The phosphite free of active hydrogen groups is introduced into the isocyanate component. The isocyanate-reactive component and the stoichiometric excess of the isocyanate component are reacted in the presence of the phosphite to make the isocyanate prepolymer. The “stoichiometric excess” of the isocyanate component is more specifically defined as an amount sufficient to make the isocyanate prepolymer having the NCO content of from about 20 to about 35%, more typically from about 23 to about 31%, most typically from about 25 to about 30%.

As alluded to above, the polyurethane foam includes the reaction product of the isocyanate prepolymer and the second isocyanate-reactive component in the presence of the blowing agent. The second isocyanate-reactive component may be identical to or different from the isocyanate-reactive component that is used to make the isocyanate prepolymer. However, the second isocyanate-reactive component typically also has a nominal functionality of at least 3. The blowing agent may be any blowing agent that is known for making polyurethane foams. Specifically, the blowing agent may be selected from the group of chemical blowing agents, physical blowing agents, and combinations thereof.

To make the polyurethane foam, the isocyanate prepolymer is provided. The method of making the polyurethane foam may optionally include the steps that are used to make the isocyanate prepolymer. The isocyanate prepolymer and the second isocyanate-reactive component are reacted in the presence of the blowing agent to make the polyurethane foam.

To make the composite article, the polyurethane foam core is provided. The polyurethane foam core has an outer surface the elastomeric layer is formed on the outer surface of the polyurethane foam core. To form the elastomeric layer, the outer surface of the polyurethane foam core is typically covered with a fabric. The fabric is typically formed from a reinforcing fiber, such as fiberglass; however, it is to be appreciated that the fabric may be formed from any reinforcing fiber that is known in the art, such as carbon fiber. Fiberglass is especially suitable when the composite article is the surfboard.

The fabric may be impregnated with an elastomeric composition. More specifically, after covering the polyurethane foam core with the fabric, the elastomeric composition may be applied onto the fabric, thereby impregnating the fabric and curing to form the elastomeric layer. As known in the art, additional layers of the elastomeric composition may be applied, or other compositions may be applied to the elastomeric layer depending on a surface texture and appearance that is desired for the composite article.

Specific examples of suitable elastomeric compositions that may be used to impregnate the fabric include those selected from the group of epoxy resin, polyester resin, and combinations thereof, which are especially suitable when the composite article is the surfboard. However, it is to be appreciated that the specific elastomeric composition that is used to impregnate the fabric is dependent upon the intended use of the composite article, and other elastomeric compositions may also be suitable.

### EXAMPLES

An isocyanate prepolymer of the subject invention is made according a method of the subject invention, as set forth above. More specifically, the isocyanate component is provided in a reactor. The phosphite free of active hydrogen groups is introduced into the isocyanate component in the reactor. The aromatic carboxylic acid chloride is provided into the reactor with the isocyanate component and the phosphite. The contents of the reactor are then heated to a temperature of about 60° C. The isocyanate-reactive component and the stoichiometric excess of the isocyanate component are reacted in the presence of the phosphite and the aromatic carboxylic acid chloride to make the isocyanate prepolymer by providing the isocyanate-reactive component dropwise into the reactor with the isocyanate component, the phosphite, and the aromatic carboxylic acid chloride while maintaining the temperature of the contents of the reactor above 60° C. but below 70° C. The temperature of the contents of the reactor is maintained for about 1 hour at 60° C., after which the contents of the reactor are cooled to a temperature of about 30° C. The isocyanate prepolymer will have B* values on the CIE L*A*B* Color Space Specification as indicated in Table 1, with lower B* values indicating less yellowness and, thus, less discoloration as compared to higher B* values. APHA color values, which are derived from the CIE L*A*B* Color Space values, are also shown, with lower APHA color values corresponding to less discoloration.

Additional Examples are also provided with alternative phosphites that may also be part of the present invention, but that may be less preferred due to lower reduction of discoloration in the isocyanate prepolymer. A Comparative Example of an isocyanate prepolymer is also provided that is made in the same manner as set forth above, but in the absence of the phosphite.

Specific isocyanate components, isocyanate-reactive components, phosphites, and aromatic carboxylic acid chlorides, as well as amounts of each of those that may be used to make the isocyanate prepolymer, are set forth in Table 1 below, with all amounts in parts by weight based on 100 parts by weight of the isocyanate component, the phosphite, the aromatic carboxylic acid chloride, and the isocyanate-reactive component on a pre-reaction basis unless otherwise indicated.

TABLE 1

| Component | Ex. A | Ex. B | Ex. C | Ex. D | Ex. E |
|---|---|---|---|---|---|
| Isocyanate | 95.60 | 91.47 | 91.47 | 91.47 | 91.45 |
| Component | | | | | |
| Phosphite A | 0.028 | 0.023 | 0.028 | 0.026 | 0.000 |
| Phosphite B | 0.000 | 0.000 | 0.000 | 0.000 | 0.045 |
| Phosphite C | 0.000 | 0.000 | 0.000 | 0.000 | 0.000 |
| Phosphite D | 0.000 | 0.000 | 0.000 | 0.000 | 0.000 |
| Aromatic | 0.005 | 0.005 | 0.005 | 0.005 | 0.005 |
| Carboxylic Acid | | | | | |
| Chloride | | | | | |
| Isocyanate- | 4.37 | 8.50 | 8.50 | 8.50 | 8.50 |
| Reactive | | | | | |
| Component | | | | | |
| Total | 100.00 | 100.00 | 100.00 | 100.00 | 100.00 |
| APHA Color Value | 98 | 98 | 98 | 98 | 80 |
| of Isocyanate | | | | | |
| Component | | | | | |
| B* Value of | 3.5 | 3.2 | 3.5 | 3.3 | 3.8 |
| Isocyanate | | | | | |
| Prepolymer | | | | | |
| APHA Color Value | 95 | 86 | 93 | 87 | 100 |
| | | | | Comp | Comp |
| Component | Ex. F | Ex. G | Ex. H | Ex. A | Ex. B |
| Isocyanate | 91.48 | 91.46 | 91.45 | 91.49 | 95.62 |
| Component | | | | | |
| Phosphite A | 0.000 | 0.000 | 0.000 | 0.000 | 0.000 |
| Phosphite B | 0.000 | 0.000 | 0.051 | 0.000 | 0.000 |
| Phosphite C | 0.019 | 0.000 | 0.000 | 0.000 | 0.000 |
| Phosphite D | 0.000 | 0.034 | 0.000 | 0.000 | 0.000 |
| Aromatic | 0.005 | 0.005 | 0.005 | 0.005 | 0.005 |
| Carboxylic Acid | | | | | |
| Chloride | | | | | |
| Isocyanate- | 8.50 | 8.50 | 8.50 | 8.50 | 4.37 |
| Reactive | | | | | |
| Component | | | | | |
| Total | 100.00 | 100.00 | 100.00 | 100.00 | 100.00 |
| APHA Color Value | 80 | 103 | 103 | 103 | 98 |
| of Isocyanate | | | | | |
| Component | | | | | |
| B* Value of | 5.3 | 7.9 | 3.5 | 8.0 | 10.8 |
| Isocyanate | | | | | |
| Prepolymer | | | | | |
| APHA Color Value | 131 | 197 | 90.3 | 199 | 269 |

Isocyanate Component is Lupranate ® MI commercially available from BASF Corporation of Wyandotte, MI.
Phosphite A is tributyl phosphite.
Phosphite B is diisodecylphenyl phosphite.
Phosphite C is dibutyl phosphite.
Phosphite D is triphenyl phosphite.
Aromatic Carboxylic Acid Chloride is benzoyl chloride.
Isocyanate-Reactive Component is a pentaerythritol-initiated propylene oxide adduct commercially available from BASF Corporation

The chemical features of the phosphites used for the Examples, along with color data for resulting prepolymers including those phosphites, are summarized in Table 2.

TABLE 2

| | | Phosphite | | | |
|---|---|---|---|---|---|
| | | Type | | | |
| | Phosphite Type | (Aliphatic | | | APHA |
| | (di or tri- | or | Amount | B* | Color |
| Phosphite | substituted) | aromatic) | (ppm) | Value | Value |
| None | NA | NA | NA | 8-10.8 | 199-269 |
| Phosphite A | Tri-substituted | Aliphatic | 230-260 | 3.2-3.5 | 86-97 |
| Phosphite B | Tri-substituted | Mixed | 450-510 | 3.5-3.8 | 90-100 |
| | | aliphatic | | | |
| | | aromatic | | | |
| Phosphite C | Di-substituted | Aliphatic | 190 | 5.3 | 131 |
| Phosphite D | Tri-substituted | Aromatic | 340 | 7.9 | 197 |

It is apparent, with reference to Tables 1 and 2 above, that use of Phosphites A and B result in more significant reduction in discoloration of the isocyanate prepolymer than Phosphites C and D, and that use of Phosphite C results in some reduction in discoloration of the isocyanate prepolymer, while Phosphite D apparently results in little or no reduction in discoloration of the isocyanate prepolymer. Without intending to be bound to any particular theory, it is believed that certain chemical features of the phosphite ensure minimum discoloration of the prepolymer, as indicated by comparatively lower B* values and Low APHA color values. Preferred phosphites are tri-substituted aliphatic or mixed aliphatic/aromatic phosphites, such as Phosphites A and B, while di-substituted aliphatic phosphites, such as Phosphite C, are also preferred. Most preferred are tri-substituted aliphatic phosphites, such as Phosphite A, which affords the least discoloration at the lowest ppm levels.

The invention has been described in an illustrative manner, and it is to be understood that the terminology which has been used is intended to be in the nature of words of description rather than of limitation. Obviously, many modifications and variations of the present invention are possible in light of the above teachings. It is, therefore, to be understood that within the scope of the appended claims, the invention may be practiced otherwise than as specifically described.

1. A method of making polyurethane foam, said method comprising the steps of:
providing an isocyanate component;
introducing a phosphite free of active hydrogen groups into the isocyanate component;
reacting an isocyanate-reactive component and a stoichiometric excess of the isocyanate component in the presence of the phosphite to make an isocyanate prepolymer;
reacting the isocyanate prepolymer and a second isocyanate-reactive component in the presence of a blowing agent to make the polyurethane foam.

2. A method as set forth in claim 1 wherein the phosphite is present in an amount of from about 0.02 to about 0.055 parts by weight based on 100 parts by weight of the isocyanate component, the phosphite, and the isocyanate-reactive component on a pre-reaction basis.

3. A method as set forth in claim 1 wherein the phosphite is represented by the general structure: 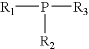
wherein R₁, R₂, and R₃ are independently selected from the group of an alkylene radical having at least 3 carbon atoms, an aryl radical, and combinations thereof, provided that at least two of R₁, R₂, and R₃ comprise the alkylene radical having at least 3 carbon atoms.

4. A method as set forth in claim 3 wherein the phosphite is selected from the group of tributyl phosphite, diisodecylphenyl phosphite, and combinations thereof.

5. A method as set forth in claim 1 where the stoichiometric excess of the isocyanate component is further defined as an amount sufficient to make the isocyanate prepolymer having an NCO content of from about 20 to about 35%.

6. A method as set forth in claim 1 wherein the isocyanate-reactive component used to make the isocyanate prepolymer has a nominal functionality of at least 3.

7. A method as set forth in claim 6 wherein the isocyanate-reactive component used to make the isocyanate prepolymer comprises a pentaerythritol-initiated propylene oxide adduct.

8. A method as set forth in claim 1 wherein the isocyanate prepolymer is formed in the presence of an additive selected from the group of aromatic carboxylic acid chlorides, inorganic acids, aliphatic carboxylic acids, and combinations thereof.

9. A rigid polyurethane foam made in accordance with the method as set forth in claim 1.

10. A method of making polyurethane foam, said method comprising the steps of:
providing an isocyanate prepolymer comprising the reaction product of an isocyanate-reactive component and a stoichiometric excess of an isocyanate component in the presence of a phosphite free of active hydrogen groups;
reacting the isocyanate prepolymer and a second isocyanate-reactive component in the presence of a blowing agent to make the polyurethane foam.

11. A method as set forth in claim 10 wherein the phosphite is present in an amount of from about 0.02 to about 0.055 parts by weight based on 100 parts by weight of the isocyanate component, the phosphite, and the isocyanate-reactive component on a pre-reaction basis.

12. A method as set forth in claim 10 wherein the phosphite is represented by the general structure: 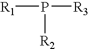
wherein R₁, R₂, and R₃ are independently selected from the group of an alkylene radical having at least 3 carbon atoms, an aryl radical, and combinations thereof, provided that at least two of R₁, R₂, and R₃ comprise the alkylene radical having at least 3 carbon atoms.

13. A method as set forth in claim 12 wherein the phosphite is selected from the group of tributyl phosphite, diisodecylphenyl phosphite, and combinations thereof.

14. A method as set forth in claim 10 where the isocyanate prepolymer has an NCO content of from about 20 to about 35%.

15. A method as set forth in claim 10 wherein the isocyanate-reactive component used to make the isocyanate prepolymer has a nominal functionality of at least 3.

16. A method as set forth in claim 15 wherein the isocyanate-reactive component used to make the isocyanate prepolymer comprises a pentaerythritol-initiated propylene oxide adduct.

17. A rigid polyurethane foam made in accordance with the method as set forth in claim 10.

18. A method of making an isocyanate prepolymer, said method comprising the steps of:
providing an isocyanate component;
introducing a phosphite free of active hydrogen groups into the isocyanate component;
reacting an isocyanate-reactive component and a stoichiometric excess of the isocyanate component in the presence of the phosphite to make an isocyanate prepolymer.

19. A method as set forth in claim 18 wherein the phosphite is present in an amount of from about 0.02 to about 0.055 parts by weight based on 100 parts by weight of the isocyanate component, the phosphite, and the isocyanate-reactive component on a pre-reaction basis.

20. A method as set forth in claim 18 wherein the phosphite is represented by the general structure: 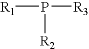
wherein R₁, R₂, and R₃ are independently selected from the group of an alkylene radical having at least 3 carbon atoms, an aryl radical, and combinations thereof, provided that at least two of R₁, R₂, and R₃ comprise the alkylene radical having at least 3 carbon atoms.

21. A method as set forth in claim 20 wherein the phosphite is selected from the group of tributyl phosphite, diisodecylphenyl phosphite, and combinations thereof.

22. A method as set forth in claim 18 where the stoichiometric excess of the isocyanate component is further defined as an amount sufficient to make the isocyanate prepolymer having an NCO content of from about 20 to about 35%.

23. A method as set forth in claim 18 wherein the isocyanate-reactive component has a nominal functionality of at least 3.

24. A method as set forth in claim 23 wherein the isocyanate-reactive component comprises a pentaerythritol-initiated propylene oxide adduct.

25. A method as set forth in claim 18 wherein the isocyanate prepolymer is formed in the presence of an additive selected from the group of aromatic carboxylic acid chlorides, inorganic acids, aliphatic carboxylic acids, and combinations thereof.
